(19) United States
(12) Patent Application Publication
(10) Pub. No.: US 2015/0300148 A1
(43) Pub. Date: Oct. 22, 2015

(54) METHODS OF INSPECTING OILFIELD TOOLS

(71) Applicant: Michael Eric Johnson, The Woodlands, TX (US)

(72) Inventor: Michael Eric Johnson, The Woodlands, TX (US)

(73) Assignee: TRC Services, Inc., The Woodlands, TX (US)

(21) Appl. No.: 14/253,988

(22) Filed: Apr. 16, 2014

(51) Int. Cl. E21B 44/00; G06Q 20/10

(52) U.S. Cl. CPC E21B 44/00; G06Q 20/10

(57) ABSTRACT

Computer based methods and systems for monitoring a wellbore and preventing equipment damage are disclosed. The computer based methods allow a wellbore operator to subscribe to the services of an inspection services company for a certain period of time to inspect the wellbore through sonic and mechanical analysis and relay any changes in wellbore or pump conditions to the wellbore operator through a computer network.

### FIELD

The embodiments of the invention disclosed herein relate to methods of preventing damage to oil wells and to optimizing the production and measuring the parameters of production from oil wells.

### BACKGROUND

Downhole operations involving the pumping of oil are used to suck or otherwise lift fluids such as oil from subsurface formations to the surface after the initial pressure from the subsurface formations has subsided.

In order to pump oil from subterranean formations through a well bore and out the wellhead, workers need to know the pumping fluid level so as to optimize the well productivity through adjustment of the oil pumping rate. By knowing this fluid level, oilfield workers will have a better understanding of subsurface formations and well performance.

Further, during the process of pumping oil from subsurface formations through the wellbore, equipment can become damaged. Further, there is a risk of low oil levels damaging the pumping equipment. Analysis of the wellbore conditions such as equipment and casing conditions during pumping operations can eliminate or reduce the amount of time a well must be taken offline for repairs.

As the downhole pump parts start to wear out, the pumping operations loose efficiency. Without periodic analysis of the fluid level of the well and the condition of the pumping equipment, the only sign that the well is not operating in optimal conditions is to notice a sharp decrease in pump performance and a decrease in the oil being brought to the surface.

In contrast to having too low of an oil level, there can be issues with too high of a level of oil (pumping fluid level). The pumping fluid level is related to the wellbore pressure, which itself is the casing pressure, the gas column pressure and the liquid column pressure above the subsurface formation. When the pump does not have the ability to remove the correct amount of liquid from the well, a column of liquid or a high casing pressure can result. The increase in wellbore pressure can restrict the flow of fluid from the formation into the wellbore, thereby preventing the maximum amount of production from the oil well.

To perform checks on the well, a well operator has to either train his own employees in the art of well analysis or contract with outside service companies to bring their own staff on site to check the well. Because of this, well operators will often forego testing and use estimation due to their own experience in oil production. Further, as low levels of oil can cause pump damage, well operators sometimes pump at less than optimum conditions to avoid such problems. Doing this reduces the risk of damage to downhole pump components, but at a cost of less oil delivery from the well.

By contracting with outside services, which are capable of monitoring one or all of the oil wells simultaneously using skilled workers trained in monitoring operations, a well operator would have the information necessary to ensure that the well is producing at an optimum rate and that equipment damage is avoided.

Echo sounding to determine fluid depth is known in the art as shown in U.S. Pat. No. 5,200,894 for example. One such method of using echo sounding is to use equipment known as a sonic well analyzer.

A sonic well analyzer is often a computerized instrument for acquiring liquid level data, acoustic pressure transient data, dynamometer data, and motor power/current data. Further, this equipment package often contains a computer, software, analog to digital converters, and sensors.

A sonic well analyzer should function as an integrated artificial lift data acquisition and diagnostic system to allow a well operator to maximize oil and gas production and minimize operating expense. Well productivity, reservoir pressure, overall efficiency, equipment loading and well performance are derived from the combination of measurements of surface pressure, acoustic liquid level, dynamometer, power and pressure transient response.

Preferably, a sonic well analyzer is used with dynamometer load cells to gather dynamometer data which is processed and analyzed to determine the loading and performance of the surface unit, rod string, and the downhole pump. Dynamometers are able to perform analysis including measurements of valve loads and analysis of mechanical torque. Types of dynamometers include the polished rod transducer and the horseshoe transducer.

The polished rod transducer measures the change in diameter of the polished rod and converts the change in diameter to the change in load on the polished rod. Software guides the operator in properly installing the transducer onto the polished rod. The acceleration data is twice integrated in software to determine polished rod position. The change in loads and the calculated positions from the acceleration data are used to generate a surface card. Software generates a pump card using a wave equation from the acquired load and position data. The surface and downhole cards are calibrated by software using the principle that the pump card should have a zero mechanical load below the pump on the downstroke when the traveling valve is open. Software performs these calculations and displays a surface and pump card.

The horseshoe transducer should be used in special cases where the drag or damping factor on the sucker rods cannot be estimated with reasonable accuracy. Further, this transducer is used to accurately measure the polished rod load and position.

In addition to using sonic well analyzers and dynamometers, a power test can be performed on the well pump to measure both motor power and current. Most pumping unit motors consume electricity when the weights are horizontal and generate electricity when the weights are vertical at the top and bottom of the polished rod stroke. A power transducer is able to measure the power usage of the motor. The power consumed and the power generated by the motor are both measured and recorded into a computer storage device. This data is analyzed to determine the proper size motor for the well, the loading of the motor and the cost of the electricity supplied to the motor. The power data can be further analyzed to determine instantaneous motor torque. This can be converted to gearbox torque by software-applied efficiencies and the pumping unit speed that is determined from the software. The upstroke and downstroke gearbox torque are both calculated and a recommended distance to move the counterweights to balance the unit is displayed.

Still another test that can be performed is a pressure transient test. This test can be performed to obtain pressure buildup data.

Regarding the sonic well analyzer, the analyzer consists of a sonic gun and microphone assembly. The sonic gun generates a pressure pulse downhole and the microphone converts the acoustic pressure pulse into an electrical signal that can be read by a computer. The sonic gun should be able to generate enough pressure to generate a pulse to count the collars on the tubing joints down to the liquid level. This can be stored in computer memory for future comparisons. Secondly, the sonic gun should be able to generate a pressure pulse of sufficient strength to cause the reflected pressure wave from the liquid level to be readily distinguishable.

Typically, the sonic gun uses a carbon dioxide gas or nitrogen charge to generate the sound wave that will travel down the well casing. The elapsed time for the echo to come back allows for mathematical determination of the depth of the fluid down hole.

Preferably, technicians operating the sonic well analyzer would use the outputs to determine if there is a problem. The technicians are then able to direct the well operator to change parameters such as pump speed to correct any problems found.

Preferably, the outputs measured by the technicians include: 1) fluid level from the surface; 2) measure the rod string and fluid load from the polished rod; 3) measure the rod string and fluid load from an adaptable load cell; 4) calculate pump performance (efficiency) and position during a pumping cycle; 5) measure and calculate load on the structure, gearbox, and rod string; 6) check counter balance efficiency and how to rebalance correctly; and 7) measure power consumption and efficiency.

A sucker rod is a rigid rod used in the oil industry to join together the surface and downhole components of a reciprocating piston pump installed in an oil well. These rods are typically between 25 and 30 feet (7 to 9 meters) in length, and threaded at both ends.

One of the problems well operators face is that the processing parameters for product in this application continually change with the overall fluid level. The fluid level controls the amount of load exerted on the rod string. This in turn changes the performance of the pump due to back pressure, i.e. the stretch of the rod string due to that weight, which makes the original bottom hole spacing incorrect. This can cause the rods to tag (hit bottom) and damage the rod string. Also, when the fluid is completely pumped off and the rod string continues to run without fluid, the pump and rods can be destroyed.

### SUMMARY

Certain embodiments of the invention disclosed herein pertain to an electronic subscriber based system and method of preventing damage to sucker rods. More specifically, the system comprises: 1) a sonic gun capable of producing a sonic blast and a microphone operatively connected to a wellbore having a liquid level, tubing, and tubing collars; wherein upon firing the sonic gun, the microphone receives an echo from the sonic blast after the sonic blast has reached the liquid level; and a recording device capable of recording the echo received by the microphone, and wherein the recording device transmits the echo recording to an analysis computer; 2) an analysis computer capable of determining the liquid level in the wellbore; 3) a wellbore operator computer for sending and retrieving data, wherein the well operator computer is connected to a network; and 4) an inspection services computer for sending and receiving data, wherein the inspection services computer is connected to the network, and wherein the wellbore operator computer sends funds and data through the network to the inspection services computer.

In certain other embodiments, the wellbore operator sends funds to the inspection services company prior to, or after the inspection services company fires the sonic gun. In certain embodiments, the type of funds sent include, but are not limited to: a check, a cashier's check, cash, a bank draft, a debit card, a credit card and the like. In certain specific embodiments, the wellbore operator sends the funds electronically through the wellbore operator computer to the inspection services computer. In such embodiments, the funds can be any electronic funds such as a bank draft, a credit card transaction, a debit card transaction or combinations thereof. It is understood that if other forms of electronic funds are developed and are capable of being transferred from one computer to another, then the scope of the invention encompasses those forms of electronic funds.

In furtherance of this system, upon transfer of funds and data from the well operator computer to the inspection services computer: 1) an inspection services company fires the sonic gun a plurality of times; 2) the analysis computer determines the liquid level in the wellbore on each of the plurality of times to generate well bore data, the data comprising the difference in fluid level between at least two times of the plurality of times; and 3) the inspection services company obtains the wellbore data and transmits the wellbore data to a wellbore operator. Still further, upon receipt of the data, the wellbore operator can adjust pumping speed of a pump which is pumping liquid from the wellbore to prevent damage to the sucker rods.

In further embodiments concerning the analysis computer, the analysis computer is either also the inspection services computer or is connected to a network also connected to the inspection services computer. In further embodiments, the analysis computer is further capable of determining pumping speed of the pump and pressure within the wellbore.

Regarding the firing of the sonic gun, a duration exists between the plurality of times, and the duration is daily, weekly, monthly, quarterly per year, twice a year or a combination thereof. In such embodiments, the data sent by the wellbore computer is received by the inspection services computer and the data comprises the duration and the plurality of times the sonic gun is fired. Further, in such embodiments, the funds sent by the wellbore computer are received by the inspection services computer.

In further embodiments of the invention disclosed herein, the sonic gun is connected to the inspection services computer through the network. In such embodiments, the inspection services company sends a signal through the inspection services computer to fire the sonic gun. Still further, the inspection services computer signals the sonic gun to fire the plurality of times and the duration specified by the data sent by the wellbore computer and upon receipt of the funds by the inspection services computer.

In further embodiments, the wellbore operator is able to view the wellbore data transmitted to the wellbore computer from the inspection services computer through the network.

### BRIEF DESCRIPTION OF THE DRAWINGS

In order that the manner in which the above-recited and other enhancements and objects of the invention are obtained, we briefly describe a more particular description of the invention briefly rendered by reference to specific embodiments thereof which are illustrated in the appended drawings. Understanding that these drawings depict only typical embodiments of the invention and are therefore not to be considered limiting of its scope, we herein describe the invention with additional specificity and detail through the use of the accompanying drawings in which:

FIG. 1 is a schematic representation of the present invention.

### LIST OF REFERENCE NUMERALS

30 wellbore operator computer
20 network
30 inspection services computer
40 sonic gun
50 microphone
60 wellbore
70 analysis computer

### DESCRIPTION

The embodiments of the invention disclosed herein pertain to a subscription or networked solution to monitoring and preventing damage to sucker rods in reciprocating pumps before they happen. Also, the methods herein allow for pump optimization based on known baselines and changes in operating environment such as changes in liquid level in a wellbore or in gas or liquid pressure in the wellbore.

Ideally, an operator will want to ensure that his equipment does not become damaged during the oil extraction process. Therefore, many wellbore operators will hire a company to “shoot” the wellbore upon commencement of pumping operations to know the liquid level within the pump. The wellbore operator, through experience then makes a best guess as to the liquid level after pumping.

In the embodiments of the invention disclosed herein, the wellbore operator operates a wellbore computer, either at the wellbore site or elsewhere. The wellbore computer typically has a graphical user interface and is connected to a network such as the internet.

Likewise, in the embodiments of the invention disclosed herein, there exists an inspection services company offering a subscription fee to inspect the wellbore. The fee structure may also be a fee per shot. The inspection services company operates an inspection services computer which receives funds and data from the wellbore computer. The funds are for payment of services. The data tells the inspection services company how often the well is to be shot and for how long. As non-limiting examples, the data can tell the inspection services company that for the next 18 months, the well is to be shot weekly to gather liquid level data, and optionally pumping speed and wellbore pressure data.

To gather this data, a sonic gun is used on site along with a microphone and transducers such as pressure transducers and the like as discussed above. The data is collected by an analysis computer and wellbore data is generated by the inspection services computer. In such embodiments, the analysis computer is either connected to the inspection services computer through a network or is actually a part of the inspection services computer.

In many embodiments, the inspection services company operating the inspection services computer will transmit the wellbore data generated via the analysis computer and the inspection services computer to the wellbore computer such that the wellbore operator will know if the fluid level or pressure level has changed, the pressure has changed, the pump speed has changed or a combination thereof.

Implementation

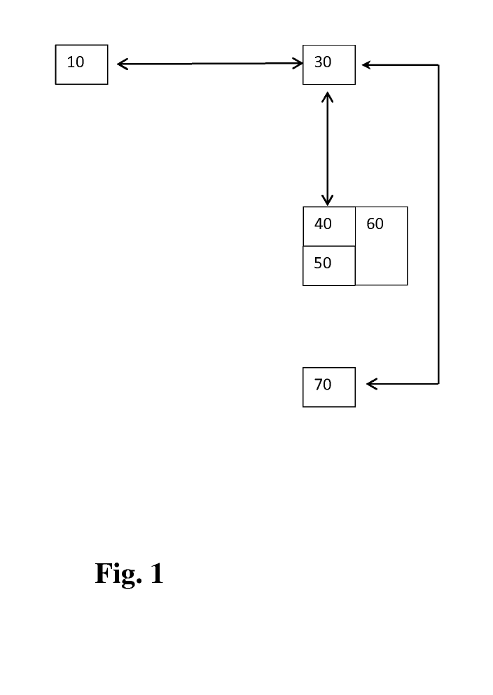

FIG. 1 is a schematic representation of the present invention. As illustrated in FIG. 1, the method of the invention employs the system. More specifically, a wellbore operator computer 10 is used by a wellbore operator to send and retrieve data. The wellbore operator submits funds and data through the wellbore operator computer 10 through the network 20 to an inspection services computer 30. The inspection services computer 30 is run by an inspection services company. Upon receipt of the data, which includes the number of times the well is to be tested and the duration between each time of testing, e.g. daily, weekly, monthly and the like. Upon receipt of the data by the inspection services computer 30. The inspection services computer instructs the sonic gun 40, typically through the network 20 to fire a sonic blast which is recorded by a microphone 50, in operational connection to the sonic gun at the wellbore 60. The microphone captures the echo from the sonic blast going downhole and back up and is recorded and analyzed by the analysis computer 70. The analysis computer 70 transmits the data to the inspection services company computer 30 wherein the data is stored. The data from the inspection services computer concerning the wellbore analysis is sent to the wellbore operator computer 10 so that the wellbore operator is able to make adjustments to the pumping, such as speed and pressure of the wellbore so as to avoid damage to the sucker rods used in the pumping operation.

From the foregoing description, one of ordinary skill in the art can easily ascertain the essential characteristics of this disclosure, and without departing from the spirit and scope thereof, can make various changes and modifications to adapt the disclosure to various usages and conditions. For example, we do not mean for references such as above, below, left, right, and the like to be limiting but rather as a guide for orientation of the referenced element to another element. A person of skill in the art should understand that certain of the above-described structures, functions, and operations of the above-described embodiments are not necessary to practice the present disclosure and are included in the description simply for completeness of an exemplary embodiment or embodiments. In addition, a person of skill in the art should understand that specific structures, functions, and operations set forth in the above-described referenced patents and publications can be practiced in conjunction with the present disclosure, but they are not essential to its practice.

The invention can be embodied in other specific forms without departing from its spirit or essential characteristics. A person of skill in the art should consider the described embodiments in all respects only as illustrative and not restrictive. The scope of the invention is, therefore, indicated by the appended claims rather than by the foregoing description. A person of skill in the art should embrace, within their scope, all changes to the claims which come within the meaning and range of equivalency of the claims.

1. A method of preventing damage to sucker rods, the method comprising:
A. a sonic gun capable of producing a sonic blast and a microphone operatively connected to a wellbore having a liquid level, tubing, and tubing collars; wherein upon firing the sonic gun, the microphone receives an echo from the sonic blast after the sonic blast has reached the liquid level; and a recording device capable of recording the echo receive by the microphone, and wherein the recording device transmits the echo recording to an analysis computer;
B. an analysis computer capable determining the liquid level in the wellbore;
C. a wellbore operator computer for sending and retrieving data, wherein the well operator computer is connected to a network;
D. an inspection services computer for sending and receiving data, wherein the inspection services computer is connected to the network, and wherein the wellbore operator computer sends funds and data through the network to the inspection services computer; and
wherein upon transfer of data from the well operator computer to the inspection services computer;
i. an inspection services company fires the sonic gun a plurality of times;
ii. the analysis computer determines the liquid level in the wellbore on each of the plurality of times to generate well bore data, the data comprising the difference in fluid level between at least two times of the plurality of times;
iii. the inspection services company obtains the wellbore data and transmits the wellbore data to a wellbore operator through the inspection services computer; and
wherein upon receipt of the data, the wellbore operator can adjust pumping speed of a pump which is pumping liquid from the wellbore to prevent damage to the sucker rods.

2. The system of claim 1, wherein the wellbore operator sends funds to the inspection services company in the form of a credit card transaction, cash, check, cashiers check, bank draft or combinations thereof.

3. The system of claim 2, wherein the funds are a credit card transaction, a bank draft or a combination thereof and are sent from the wellbore operator computer to the inspection services computer.

4. The system of claim 1, wherein the analysis computer is also the inspection services computer or is connected to a network also connected to the inspection services computer.

5. The system of claim 1, wherein the analysis computer is further capable of determining pumping speed of the pump and pressure within the wellbore.

6. The system of claim 1, wherein the wellbore operator computer transmits data indicating a desired duration between the plurality of times, and the duration is daily, weekly, monthly, per quarter or a combination thereof.

7. The system of claim 4, wherein the data sent by the wellbore computer is received by the inspection services computer and the data comprises the duration and the plurality of times the sonic gun is fired.

8. The system of claim 5, wherein the funds sent by the wellbore computer is received by the inspection services computer.

9. The system of claim 6, wherein the sonic gun is connected to the inspection services computer through the network and wherein the inspection services company sends a signal through the inspection services computer to fire the sonic gun.

10. The system of claim 7, wherein the inspection services computer signals the sonic gun to fire the plurality of times and the duration specified by the data sent by the wellbore computer and upon receipt of the funds by the inspection services computer.

11. The system of claim 8, wherein the analysis computer is also the inspection services computer or is connected to a network also connected to the inspection services computer.

12. The system of claim 9, wherein the inspection services computer transmits the wellbore data to the wellbore computer through the network.
